(19) United States
(12) Patent Application Publication
(10) Pub. No.: US 2013/0330511 A1
(43) Pub. Date: Dec. 12, 2013

(54) GIGAHERTZ ELECTROMAGNETIC ABSORPTION IN A MATERIAL WITH TEXTURED SURFACE

(71) Applicants: Fred Sharifi, Poolesville, MD (US); Gregory J. Parker, San Jose, CA (US)

(72) Inventors: Fred Sharifi, Poolesville, MD (US); Gregory J. Parker, San Jose, CA (US)

(21) Appl. No.: 13/492,092

(22) Filed: Jun. 8, 2012

(51) Int. Cl. B32B 3/30; B23P 13/00; B05D 5/00; B29C 43/00; B29C 45/00; B29C 59/00

(52) U.S. Cl. 428/141; 264/104; 216/13; 427/58; 29/557

(57) ABSTRACT

The disclosure relates to a material having a textured surface and exhibiting absorption of electromagnetic waves with gigahertz frequencies. The textured surface can comprise a plurality of protrusions that can permit absorption of such waves. Morphology of the plurality of protrusions can control the absorption properties, e.g., absorption coefficients or specific frequency of absorbed electromagnetic radiation, of such materials. The material can comprise an electrically conductive thermoplastic composite. At least some of the protrusions can be formed of such composite. The material having the texture surface can exhibit broadband absorption.

### BACKGROUND

In thin composites, absorption of electromagnetic (EM) waves having gigahertz frequencies, referred to herein as gigahertz EM absorption, can be accomplished by allowing for multiple layers of composites, each layer having an effective index of refraction increasing in magnitude along a stacking direction of such layers. Such structures (often referred to as Salisbury screens) can be tuned for either specific frequencies or for limited block of frequencies in the EM radiation spectrum. By construction, such structures can present nearly optimal performance for normal incident EM waves having gigahertz frequencies, whereas such structures can fail to exhibit absorption of off-normal incident EM waves with gigahertz frequencies.

Another approach to forming a material that exhibits absorption of EM waves having gigahertz frequencies generally entails adding magnetic inclusions into a thin composite in a manner such that the effective permeability (μ) of the resulting composite is substantially equal to the effective permittivity (ε) thereof, with μ and ε typically being complex numbers. Yet, at gigahertz frequencies, most magnetic inclusions that are typically employed have small (e.g., about 1 to about 20) real values and small (e.g., about 0 to about 1) imaginary values for μ/μ₀, while the composites incorporating such inclusions also typically are electrically conductive and thus have a large imaginary value for ε/ε₀. In such typical scenarios, reflection off the composite commonly poses a problem to attaining satisfactory gigahertz EM absorption. Various other magnetic materials have been utilized in other approaches without yielding broadband absorption.

### SUMMARY

The disclosure relates to materials having textured surfaces and exhibiting absorption of electromagnetic (EM) waves with gigahertz frequencies, referred to as gigahertz EM waves. A textured surface can comprise a plurality of protrusions that can permit absorption of the gigahertz EM waves. Morphology of the plurality of protrusions can control the absorption properties, e.g., absorption coefficients or specific frequency of absorbed EM radiation, of such materials. The morphology can include one or more of size of the protrusions in the plurality of protrusions, surface packing of such protrusions, surface coverage of the textured surface of the materials, effective density of carriers in the materials having the textured surface, or the like. While various exemplary embodiments and related aspects of the disclosure are illustrated with textured slabs, the materials having the textured surface can adopt other shapes. The materials having textured surfaces as described herein present enhanced gigahertz EM absorption when compared to materials formed from the same compound but without textured surfaces.

Additional aspects, features, or advantages of the subject disclosure will be set forth in part in the description which follows and annexed drawings, and in part will be apparent from such description and drawings, or may be learned by practice of the subject disclosure. The advantages of the disclosure can be realized and attained by means of the elements and combinations particularly pointed out in the appended claims. It is to be understood that both the foregoing general description and the following detailed description are exemplary and explanatory only and are not restrictive of the subject disclosure.

### BRIEF DESCRIPTION OF THE DRAWINGS

The accompanying drawings are incorporated and illustrate exemplary embodiment(s) of the disclosure and together with the description and claims appended hereto serve to explain various principles, features, or aspects of the subject disclosure.

FIG. 1 illustrates production of a textured material in accordance with at least certain aspects of the disclosure.

FIGS. 2A-2C pictorially represent exemplary materials with textured surfaces in accordance with at least certain aspects of the disclosure.

FIG. 3 presents data and simulation results for optical absorption and reflectance as a function of frequency for an exemplary material with a textured surface in accordance with at least certain aspects of the disclosure.

FIGS. 4A-4D presents data and simulation results for optical absorption, reflection, and transmission as a function of frequency for exemplary materials with textured surfaces in accordance with at least certain aspects of the disclosure.

FIGS. 5A-5B present simulation results for A and R, and T as a function of frequency for exemplary materials with textured surfaces in accordance with at least certain aspects of the disclosure.

FIGS. 6A-6B present simulation results for A and R, and T as a function of frequency for exemplary materials with textured surfaces in accordance with at least certain aspects of the disclosure.

FIGS. 7A-7B present simulation results for A and R, and T as a function of frequency for exemplary materials with textured surfaces in accordance with at least certain aspects of the disclosure.

FIG. 8 presents simulation results for A and R, and T as a function of frequency for exemplary materials with textured surfaces in accordance with at least certain aspects of the disclosure.

### DETAILED DESCRIPTION

The subject disclosure may be understood more readily by reference to the following detailed description of exemplary embodiments of the subject disclosure and to the Figures and their previous and following description.

Before the present materials, compounds, compositions, articles, devices, and/or methods are disclosed and described, it is to be understood that the subject disclosure is not limited to specific coating materials, slabs, thin films, or the like, and surface shaping processes for absorption of electromagnetic radiation having gigahertz frequencies. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

In the subject specification and in the claims which follow, reference may be made to a number of terms which shall be defined to have the following meanings: “Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Reference will now be made in detail to the various embodiment(s), aspects, and features of the subject disclosure, example(s) of which are illustrated in the accompanying drawings. Wherever possible, the same reference numbers are used throughout the drawings to refer to the same or like parts.

As described in greater detail below, in various aspects, the disclosure relates to materials having a textured surface and exhibiting absorption of EM waves having gigahertz frequencies. The textured surface can comprise a plurality of protrusions that can permit gigahertz EM absorption. Morphology of the plurality of protrusions can control the absorption properties (e.g., absorption coefficients or specific frequency of absorbed EM radiation) of such materials. The morphology can include one or more of size of the protrusions in the plurality of protrusions, surface packing of such protrusions, surface coverage of the textured surface of the materials, effective density of carriers in the materials having the textured surface, or the like. While various exemplary embodiments and related aspects of the disclosure are illustrated with textured slabs, the materials having the textured surface in accordance with the disclosure can adopt other shapes.

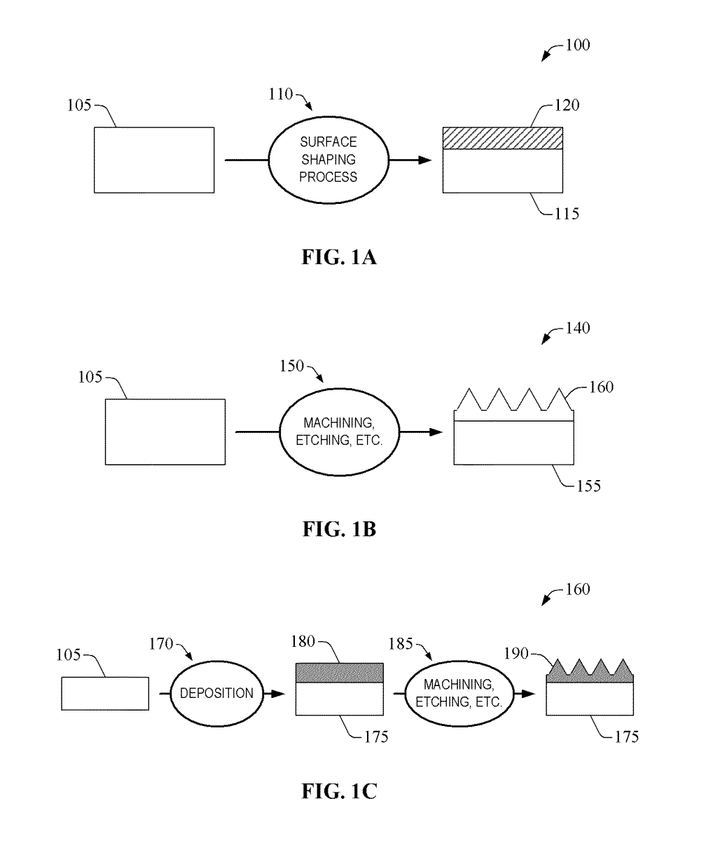

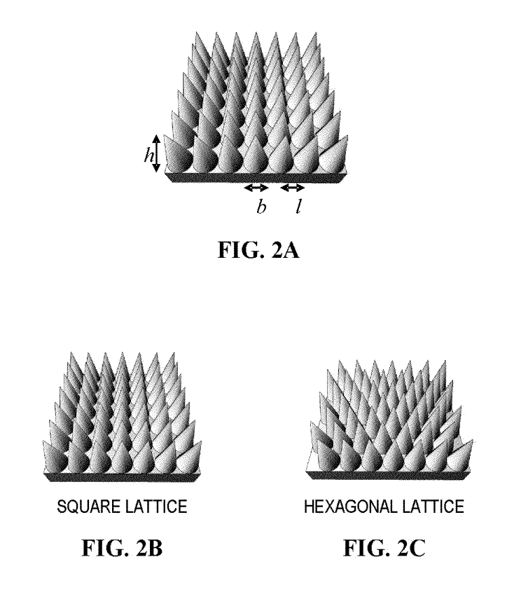

Referring to the drawings, FIG. 1A illustrates high-level block diagrams of production of a textured material in accordance with at least certain aspects of the disclosure. The textured material can be a material having a textured surface that can be exposed to incident EM radiation, such as EM waves having gigahertz frequencies. As illustrated in diagram 100, a substrate 105 of a first material is submitted to a surface shaping process 110 that produces a composite material having a substrate portion 115 and a textured portion 120. The textured portion 120 can comprise a plurality of structural members, such as orifices, grooves, whiskers, protrusions, or the like (see, e.g., FIG. 2A). In one aspect, the plurality of structural members can comprise members of various shapes. In another aspect, each of the plurality of members can have a substantially common shape (cones; cylinders; pyramids; domes; half ellipsoids, cylinders, parallelepipeds including rectangular cuboids, cubes, rhombohedra; etc.) In yet another aspect, the plurality of structural members can form an ordered array, such as a periodic lattice (including lattices with basis), or a non-periodic lattice. The periodic lattice can be represented by a plurality of lattice vectors, each lattice vector representing a single structural member of the plurality of structural members. As illustrations, the periodic lattice can be a square lattice (see, e.g., FIG. 2B) or a hexagonal lattice (see, e.g., FIG. 2C). In certain embodiments, the periodic lattice can be a lattice with a basis, the basis comprising two structural members of the plurality of structural members. In still another aspect, the plurality of structural members can form a disordered array. The surface shaping process 110 can determine the morphology of the plurality of structural members. In particular, yet not exclusively, the surface shaping process 110 can comprise most any suitable process to treat a surface of the substrate 105 and yield structural members of an intended morphology (e.g., shapes, sizes, arrangements, or any combination thereof).

In one embodiment, the substrate portion 115 and the textured portion 120 can be monolithic. As illustrated in diagram 140, the surface shaping process 150 can form a textured portion 160 comprising a plurality of protrusions from machining the substrate 105 according to a predetermined design (e.g., a specific desired morphology) for the plurality of structural members. In addition or in the alternative, the shaping process 150 can form the textured portion 160 comprising the plurality of protrusions from etching the substrate 105 according to a predetermined mask design effective to yield the plurality of structural members. The predetermined mask can comprise material resilient to a chemical etcher or plasma, the material occluding portions of the substrate according to a desired pattern of structural members. Etching of the masked substrate under controlled conditions (time of exposure to etching agent, strain applied to the substrate, etc.) as part of the surface shaping process 110 yields the plurality of protrusions. It should be appreciated that the surface process 150 embodies the surface shaping process 110. It should also be appreciated that the textured portion 160 embodies the textured portion 120, and the substrate portion 155 embodies the substrate portion 115.

In another embodiment, the material having the textured portion 120 and the substrate portion 115 can be formed from a plurality of two or more materials. As illustrated in diagram 160, the surface shaping process 110 can include a deposition process 170 that can coat the substrate 105 with a layer 180. The material of the layer 180 generally is different from the material of substrate 105. For example, the material of substrate 105 can be a first conductive thermoplastic composite, and the material of the layer 180 can be a second conductive thermoplastic composite. The coated substrate comprising a substrate portion 175 and the layer 180 can be further processed according to a surface shaping process 185 to yield a textured portion 190, comprising a plurality of protrusions, and the substrate portion 175. In one implementation, the coated substrate can be machined according to a predetermined design for the plurality of protrusions. In another implementation, the coated substrate can be etched according to a predetermined mask design effective to yield the plurality of protrusions. It should be appreciated that the textured portion 190 embodies the textured portion 120 described herein.

In other embodiments, the surface shaping process 110 can permit forming the textured portion 120 from adhesive bonding of each structural member of a plurality of members to the substrate 105. In still other embodiments, the surface shaping process 110 can permit forming the textured portion 120 from ultrasonic welding of each protrusion of the plurality of protrusion to the substrate.

In one embodiment, the substrate 105 can be a thin, electrically conductive material. The substrate 105 can have a thickness smaller than about 2 mm. In one aspect, the electrically conductive material can be an electrically conductive thermoplastic composite. The electrically conductive thermoplastic composite can comprise a plurality conductive fibers dispersed in a polymer matrix. The plurality of conductive fibers can define a specific volumetric loading of the polymer matrix. As an example, the electrically conductive thermoplastic composite can be a Faradex® compound, produced by SABIC Innovative Plastics of Pittsfield, Mass. The electrically conductive material can have permittivity ε and permeability μ, with an effective index of refraction n having a real part \sqrt{εμ}, and the textured portion 120 can have structural members with characteristic sizes (height size, base diameter size, etc.) of the order of λ/\sqrt{εμ}. Here, λ is a wavelength of electromagnetic radiation impinging onto the textured portion 120. In such scenario, for wavelengths of EM radiation having gigahertz frequencies, e.g., λ in the range from about 1 cm to about 30 cm, and values of \sqrt{εμ} in the range from about 5 to about 40, the structural members of the texture portion 120 can have characteristic sizes of the order of 0.1 mm to 100 mm. Accordingly, when the surface shaping process 110 produces the textured portion 120 with structural members having such characteristic sizes, the incident gigahertz EM radiation can be absorbed at the composite material. Without intending to be bound by theory, modeling, or simulation, gigahertz EM absorption in the textured portion 120 can be understood as a result of multiple scattering—as opposed to a single scattering event in substrate 105—of the EM radiation in directions substantially parallel to a surface of the composite material and normal to the direction of incidence of such radiation. Multiple scattering of the gigahertz EM radiation can permit additional absorption to occur at the textured portion 120.

In one embodiment, the textured portion 120 can be a textured surface of the substrate 105 that results from treating (e.g., texturizing) the substrate 105 with the surface shaping process 110 to produce a plurality of protrusions located at a surface of the substrate 105. The plurality of protrusions embody the plurality of structural members discussed herein. Treating the substrate 105 with the surface shaping process 110 can yield a textured slab exhibiting absorption of electromagnetic radiation at gigahertz frequencies. To at least such end, the surface shaping process 110 can yield protrusions with characteristic sizes of the order of λ/\sqrt{εμ}, with λ being the wavelength of electromagnetic radiation having gigahertz frequencies, and ε and μ being the permittivity and permeability, respectively, of material of the substrate 105. In one embodiment, the gigahertz frequencies can span the range from about 1 GHz to about 20 GHz. The textured slab can have a thickness in the range from about 1 mm to about 60 mm.

In another embodiment, a material having a textured surface formed according aspects described herein can comprise a substrate (e.g., substrate 105) of a first material, and an assembly of a second material coupled to the substrate, the assembly comprising a plurality of protrusions (e.g., textured portion 190) located at a surface of the substrate the substrate and the assembly forming a textured slab that exhibits absorption of electromagnetic radiation at gigahertz frequencies. Such material can be referred to as a coating material.

In certain implementations, the textured slab can have a thickness from the group of about 10 mm, about 8 mm, about 6 mm, about 4 mm, about 3 mm, and about 2 mm. In other implementations, the textured can have a thickness in the range of about 2 mm to about 10 mm. With respect to the substrate, in one aspect, the substrate can have a thickness in the range of about 1 mm to about 2 mm. In another aspect, the substrate can have a thickness smaller than about 2 mm. In yet another aspect, the substrate can have a thickness greater than about 1 mm.

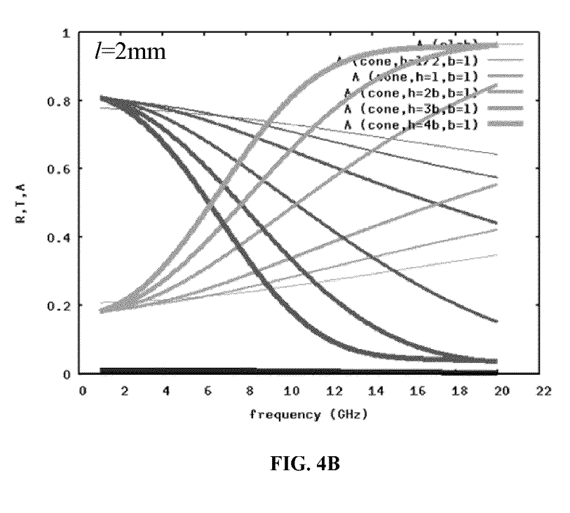

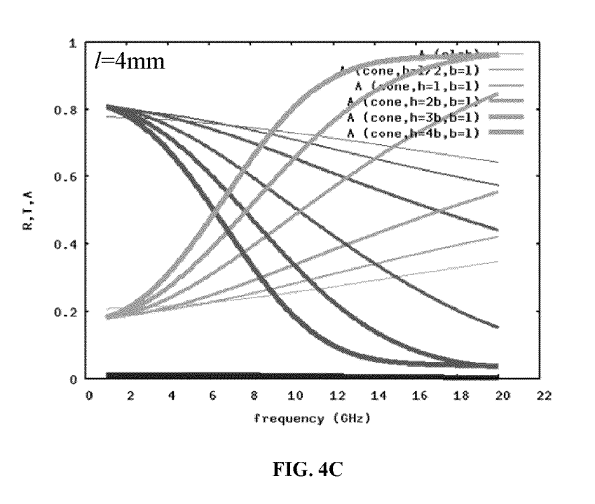

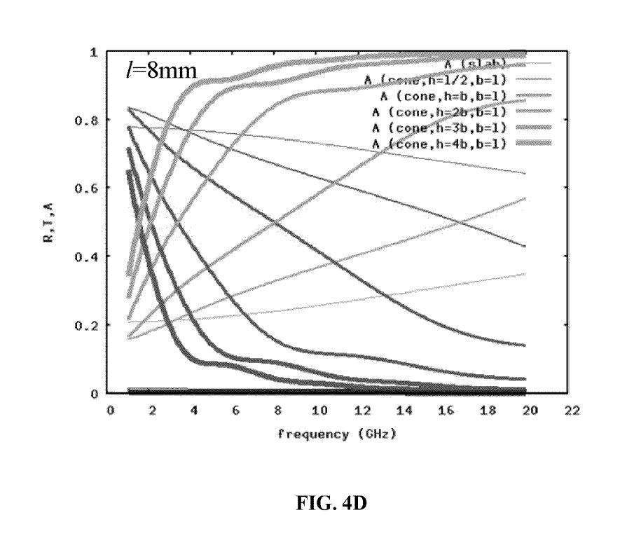

The gigahertz frequencies can span the range from about 1 GHz to about 20 GHz. As illustrated herein (see, e.g., FIGS. 4A-4D), the absorption of electromagnetic radiation at gigahertz frequencies increases with coverage of the surface of the substrate, the coverage provided by the plurality of protrusions. In another aspect, the absorption of electromagnetic radiation at gigahertz frequencies increases with height of each protrusion of the plurality of protrusions. In one aspect, the textured slab exhibits absorption of electromagnetic radiation at about 20 GHz, the absorption being enhanced by a factor of about 3 with respect to absorption of electromagnetic radiation at about 20 GHz exhibited by the substrate.

In certain embodiments, the plurality of protrusions forms a disordered array. In additional or alternative embodiments, the plurality of protrusions forms an ordered array. In one aspect, for an ordered array, the plurality of protrusions is arranged in a periodic lattice, such as a square lattice or a hexagonal lattice. As described herein, the periodic lattice can be represented by a plurality of lattice vectors, each lattice vector representing a single protrusion of the plurality of protrusions. In addition or in the alternative, the periodic lattice can be a lattice with a basis, the basis comprising two protrusions of the plurality of protrusions. The morphology of the plurality of protrusions in the coating material can comprise uniform shapes. In one aspect, each of the plurality of protrusions can have a shape comprising a circular base in contact with the surface of the substrate. In another aspect, each of the plurality of protrusions can have a shape comprising a confined base (e.g., a base of finite spatial extent) in contact with the surface of the substrate, the confined base being a lamina having a predetermined perimeter (e.g., a circumference, a parallelogram, etc.). In yet another aspect, each of the plurality of protrusions can have a shape having an aspect ratio smaller than about 4; however, protrusions having larger aspect ratios also are contemplated. It should be appreciated that for the plurality of protrusions described herein, large aspect ratios (e.g., larger than about 4) can enhance gigahertz absorption at the textured surfaces of the disclosure since, for example, reflection at such surfaces can be reduced when the gradient of the effective index of refraction is reduced in a direction normal to a surface having the plurality of protrusions.

In one embodiment, the first material and the second material can be substantially the same, the first material being a conductive thermoplastic composite. As described herein, the conductive thermoplastic composite comprises a plurality of conductive fibers dispersed in a polymer matrix. The plurality of conductive fibers can define a specific volumetric loading of the polymer matrix. In such scenario, the textured slab can be monolithically formed from machining the substrate (e.g., substrate 105) according to a predetermined design for the plurality of protrusions. In one aspect, the textured slab is monolithically formed from etching the substrate according to a predetermined mask design effective to yield the plurality of protrusions. Such etching can embody the surface shaping process 110. In another aspect, the textured slab can be formed from injection molding (e.g., another embodiment of surface shaping process 110) of a monolithic slab (e.g., substrate 105) of the conductive thermoplastic composite utilizing a textured mold shaped according to a predetermined design of protrusions to be formed onto the textured slab. While such injection molding approach is described in reference to the conductive thermoplastic composite, such approach can be utilized for other materials. In yet another aspect, the textured slab can be formed from compression molding (e.g., yet another embodiment of surface shaping process 110) of a monolithic slab (e.g., substrate 105) of the conductive thermoplastic composite followed by processing (e.g., machining or etching) of the compressed monolithic slab to yield a desired treated surface having the plurality of protrusions. While such compression molding approach is described in reference to the conductive thermoplastic composite, such approach can be utilized for other materials.

In another embodiment, the first material is a first conductive thermoplastic composite, and the second material is a second conductive thermoplastic composite. In such scenario, in one implementation, the textured slab is monolithically formed from (i) coating the substrate with a second material; and (ii) machining the coated substrate according to a predetermined design for the plurality of protrusions. In another implementation, the textured slab is monolithically formed from (i) coating the substrate with a second material; and (ii) etching the coated substrate according to a predetermined mask design effective to yield the plurality of protrusions.

In certain embodiments, substrate materials and assembly materials that are substantially the same or different, the textured slab of the coating material of the disclosure, can be formed from adhesive bonding of each protrusion of the plurality of protrusion to the substrate. In addition or in the alternative, the textured slab can be formed from ultrasonic welding of each protrusion of the plurality of protrusion to the substrate.

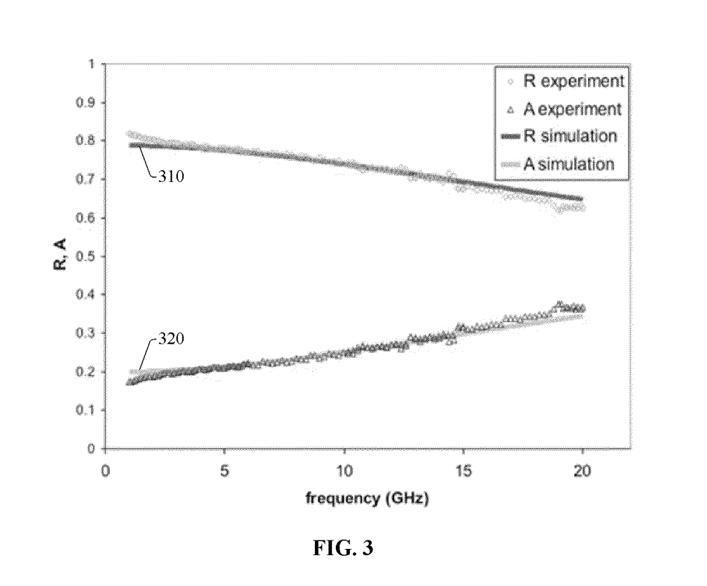

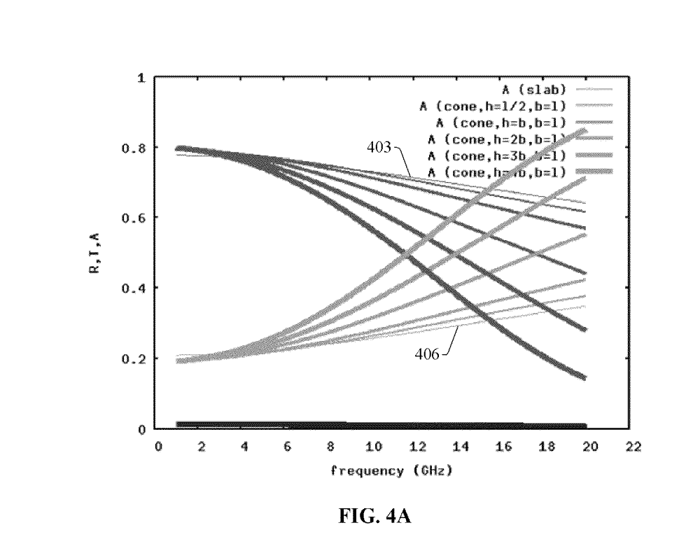

Optical properties of the materials with textured surfaces of the disclosure can be analyzed through experiment and simulation. FIG. 3 presents data and simulation results for optical absorption (labeled “A” in FIG. 3) and reflectance (labeled “R” in FIG. 3) as a function of frequency for an exemplary material with a textured surface in accordance with at least some aspects of the disclosure. In one aspect, the material with the textured surface is a textured slab (see, e.g., FIG. 2B) having a plurality of cones forming a square lattice, the cones having various aspects ratios and the square lattice having various lattice parameters. Effective permittivity ε and effective permeability μ are measured for the textured slab. In one aspect, the ratio μ/μ₀ is nearly equal to 1, and the effective e is represented accurately by a permittivity determined within the Drude approximation.

Absorption spectrum and reflectance spectrum are measured and simulated for normal incidence of an EM wave having a gigahertz frequency within a broadband portion (e.g., from 1 GHz to about 20 GHz) of the EM radiation spectrum. As shown in FIG. 3, simulation results for absorption spectrum (solid line 320) and reflectance spectrum (solid line 310) present excellent agreement with measured absorption spectrum (triangle-shaped indicia) and measured reflectance spectrum (diamond-shaped indicia), respectively. Accordingly, simulation as carried out in the disclosure is reliable for design of textured slabs with gigahertz EM absorption. Simulation of the optical absorption spectrum and the reflectance spectrum is accomplished through computation of transmitted and reflected power flux based at least in part on utilization (e.g., configuration and execution) of a finite difference time domain (FDTD) computer program (e.g., computer-executable instructions) under the assumption that the effective permittivity ε of the textured slab is accurately represented by a permittivity determined within the Drude approximation. Such assumption is supported by measurement of ε and μ, as indicated herein. In one implementation, the computational simulation package MEEP (MIT Electromagnetic Equation Propagation, as described in A. F. Oskooi, D. Roundy, M. Ibanescu, P. Bermel, J. D. Joannopoulos, and S. G. Johnson, “MEEP: A flexible free-software package for electromagnetic simulations by the FDTD method,” Computer Physics Communications 181, 687-702 (2010), http://ab-initio.mit.edu/wiki/index.php/Meep)) is employed to perform the simulations.

FIGS. 4A-4D present simulation results for optical absorption (A), reflection (R), and transmission (T) as a function of frequency for exemplary materials with textured surfaces in accordance with at least certain aspects of the disclosure. Here A+R+T=1. Simulated A, R, and T also are shown for a non-textured slab, such as substrate of a composite thermoplastic material (see, e.g., FIG. 1A). Such results for non-textured slabs are indicated with solid line 403 for the optical absorption spectrum, and solid line 406 for the reflection spectrum. The exemplary materials with textured surfaces present low transmission, as indicated by the set of traces 409. The frequencies are gigahertz frequencies that span the range from about 1 GHz to about 20 GHz. In one aspect, such exemplary materials are exemplary textured slabs comprising a plurality of cones forming a square lattice (see, e.g., FIG. 2B) wherein the lattice spacing (or lattice parameter) is substantially equal to the base diameter of each cone in the plurality of cones. In another aspect, for a specific lattice spacing, the textured slabs have cones of varying height, which defines several aspect ratios (e.g., the ratio between height and base size). In FIGS. 4A-4D, increasing aspect ratio is represented with solid line of increasing thickness. In an exemplary implementation, such textured slabs include a first exemplary textured slab comprising a plurality of cones with an aspect ratio of about 0.5. In another exemplary implementation, such textured slabs include a second exemplary textured slab comprising a plurality of cones with an aspect ratio of about 1.0. In yet another exemplary implementation, such textured slabs include a third exemplary textured slab comprising a plurality of cones with an aspect ratio of about 2.0. In still another exemplary implementation, such textured slabs include a third exemplary textured slab comprising a plurality of cones with an aspect ratio of about 3.0. In other exemplary implementations, such textured slabs include a fourth exemplary textured slab comprising a plurality of cones with an aspect ratio of about 4.0. In one aspect, the textured slabs exhibit absorption of electromagnetic radiation at about 20 GHz, wherein the absorption is enhanced by a factor of about 3 with respect to absorption of electromagnetic radiation at about 20 GHz exhibited by non-textured slab (or substrate).

As illustrated in FIGS. 4A-4D, in one aspect, the absorption of electromagnetic radiation at gigahertz frequencies increases with coverage of the surface of the non-textured slab (or substrate). The coverage can be provided by the plurality of cones. More generally, as described herein, coverage of a surface that is texturized with a process effective to yield a plurality of protrusions is provided by the plurality of protrusions. In another aspect, the absorption of electromagnetic radiation at gigahertz frequencies increases with height of the cones (e.g., each cone) of the plurality of cones. In yet another aspect, the absorption of electromagnetic radiation at gigahertz frequencies broadens to lower frequencies in the frequency range (e.g., about 1 GHz to about 20 GHz) as the height of the cones (e.g., each cone) of the plurality of cones increases.

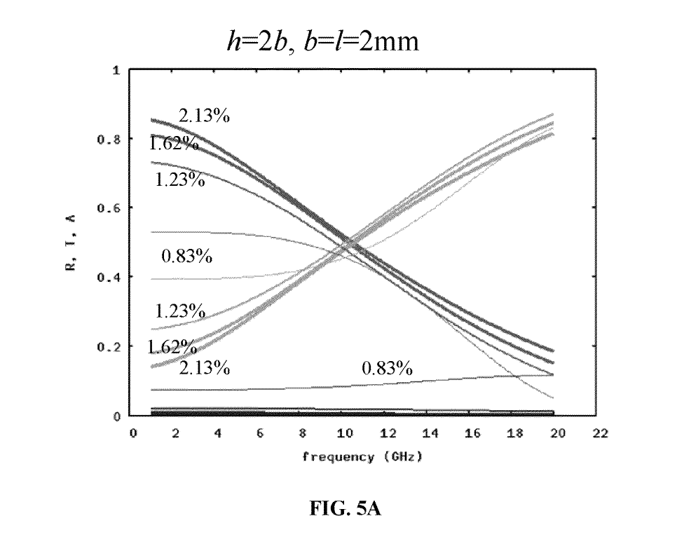

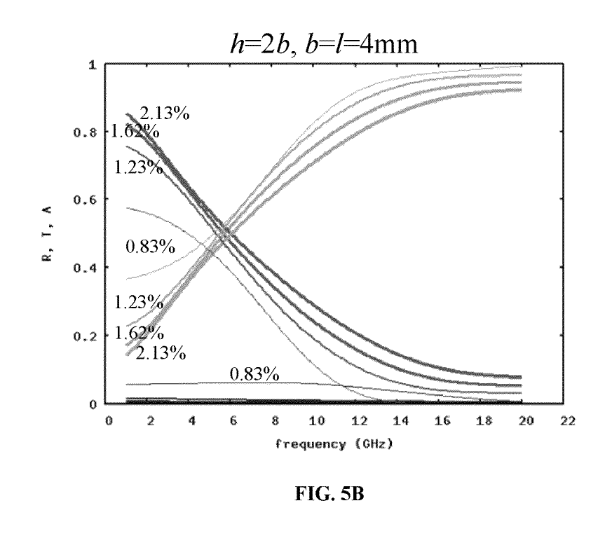

FIGS. 5A-5B present simulation results for A and R, and T as a function of frequency for exemplary materials with textured surfaces in accordance with at least certain aspects of the disclosure. The frequencies are gigahertz frequencies that span the range from about 1 GHz to about 20 GHz. Such exemplary materials are exemplary textured slabs comprising a plurality of cones forming a square lattice (see, e.g., FIG. 2B) wherein the lattice spacing (or lattice parameter) is substantially equal to the base diameter of each cone in the plurality of cones. For a specific lattice spacing, the exemplary textured slabs have cones with aspect ratios nearly equal to 2. The exemplary textured slabs have varying levels of free carriers afforded by different volume loading with conductive fibers into a material (e.g., a composite) that serves as a precursor for the textured slabs (see, e.g., FIG. 1A). Volume loading is indicated in FIGS. 5A-5B with percentages in proximity of traces for A, R, and T for the exemplary textured materials. At frequencies about 1 GHz, simulated A ranges from about 0.5 to about 0.9, R ranges from about 0.3 to about 0.4, and T has values smaller than about 0.1. For the transmission spectrum, the exemplary textured material having about 0.83% volume loading presents sizable values as compared to the transmission spectrum for higher levels of volume loading.

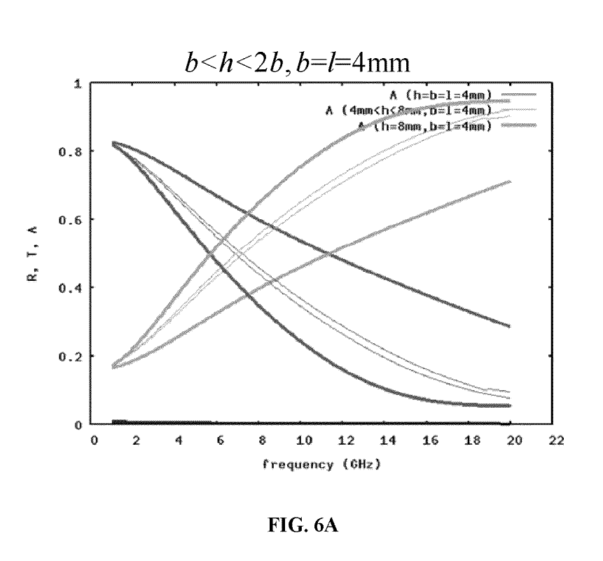

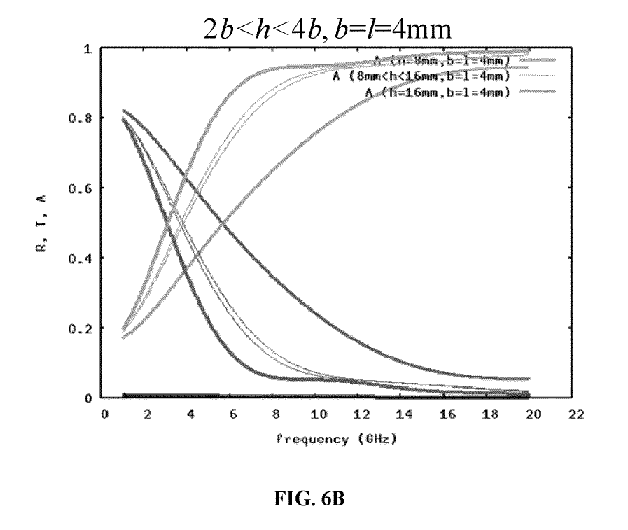

FIGS. 6A-6B present simulation results for A and R, and T as a function of frequency for exemplary materials with textured surfaces in accordance with at least certain aspects of the disclosure. The frequencies are gigahertz frequencies that span the range from about 1 GHz to about 20 GHz. Such exemplary materials are textured slabs comprising a plurality of cones forming a square lattice, wherein the lattice spacing (or lattice parameter) is substantially equal to the base diameter of each cone in the plurality of cones. The plurality of cones having cone heights that vary within a specific range (e.g., from about b to about 2b, or from about 2b to about 4b, with b being the base diameter of the cones of the plurality of cones, with the base diameter being nearly uniform through such plurality. For instance, the cone heights can be randomly distributed within such range. The simulated spectra indicate that the absorption of EM radiation having gigahertz frequencies is bound from below and above by the values of gigahertz EM absorption obtained for a plurality of cones having substantially uniform heights, with the lower bound provided by the smaller height (e.g., 2b) and the upper bound provided by the larger height (e.g., 4b).

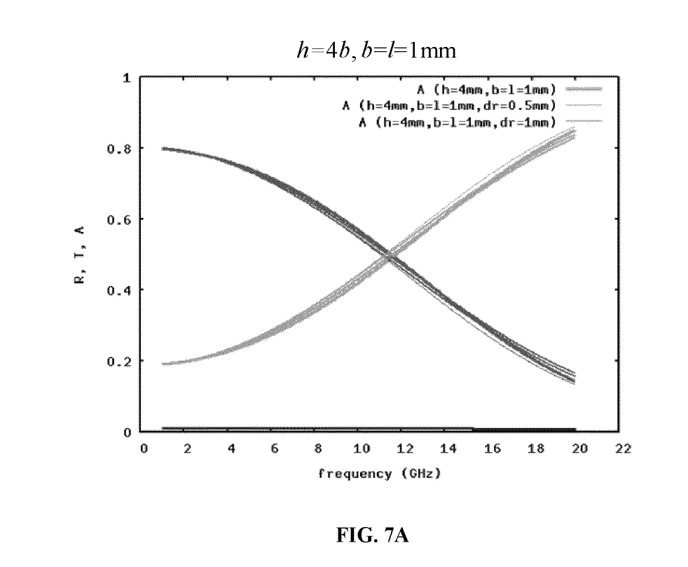

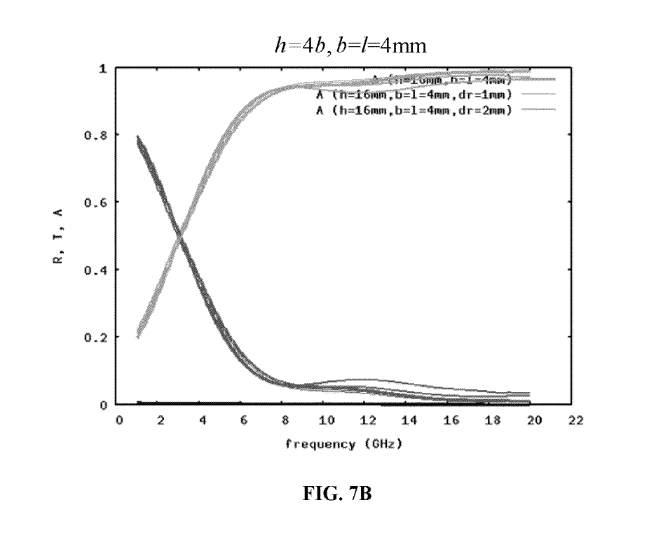

Materials having textured surfaces with disorder also can exhibit gigahertz EM absorption, as illustrated in FIGS. 7A-7B, which present simulation results for A and R, and T as a function of frequency for exemplary materials with textured surfaces having quasi-square lattice arrays of cones. As in the scenario in which the textured surface comprises a square lattice of cones, frequencies range from about 1 GHz to about 20 GHz.

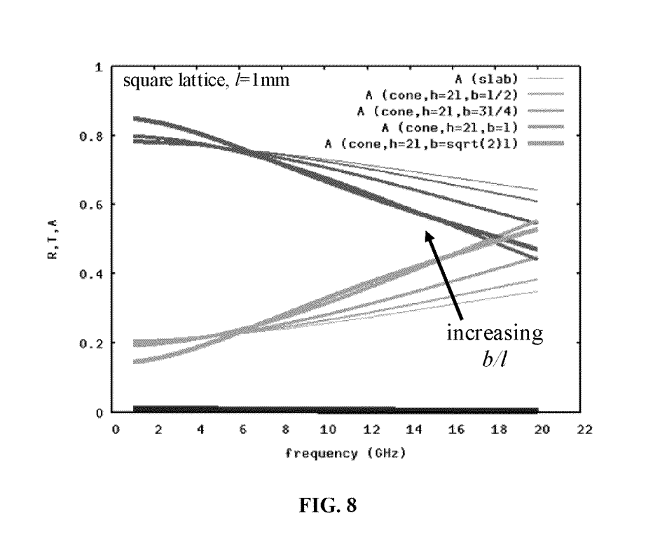

FIG. 8 presents simulation results for A and R, and T as a function of frequency for exemplary materials with textured surfaces in accordance with certain aspects of the disclosure. The frequencies are gigahertz frequencies that span the range from about 1 GHz to about 20 GHz. The exemplary materials are textured slabs comprising a plurality of cones forming a square lattice, wherein the lattice spacing and the base diameter of each cone in the plurality of cones can be different. Size of the base diameter relative to the lattice spacing can determine coverage of a surface of a substrate that serves as the precursor to a textured slab (see, e.g., FIG. 1A). For the square lattice of cones present in the exemplary materials, substantially maximal surface coverage can be accomplished for a lattice spacing (l) substantially equal to the base diameter (b). In such scenario, surface coverage is about 79%. In one aspect, as illustrated, gigahertz EM absorption can degrade in response to the surface coverage being below substantially maximal, a scenario that can result from l being greater than b. In another aspect, for a plurality of cones with base diameter greater than about the lattice spacing, gigahertz EM absorption does not present values substantively greater than those achieved in the substantially maximal coverage scenario.

It should be appreciated that the various aspects of absorption of EM radiation at gigahertz frequencies disclosed in FIGS. 4A-4D, 5A-5B, 6A-6B, 7A-7B, and 8 herein are not limited to a plurality of cones and a plurality of protrusions having other morphology also present such aspects. As described herein, the morphology can comprise one or more of shape of the protrusions in the plurality of protrusions, size of the protrusions in the plurality of protrusions, surface packing of such protrusions, surface coverage of the textured surface of the materials, or the like. In addition, the illustrated aspects of gigahertz EM absorption are not exclusively associated with or limited to a plurality of protrusions forming an ordered array (e.g., a square lattice, hexagonal lattice) The plurality of protrusions can be arranged in other configurations, or topologies, including disordered arrays, and provide a textured slab exhibiting optical absorption of EM radiation having gigahertz frequencies.

While the systems, devices, apparatuses, protocols, processes, and methods have been described in connection with exemplary embodiments and specific illustrations, it is not intended that the scope be limited to the particular embodiments set forth, as the embodiments herein are intended in all respects to be illustrative rather than restrictive.

Unless otherwise expressly stated, it is in no way intended that any protocol, procedure, process, or method set forth herein be construed as requiring that its acts or steps be performed in a specific order. Accordingly, in the subject specification, where description of a process or method does not actually recite an order to be followed by its acts or steps or it is not otherwise specifically recited in the claims or descriptions of the subject disclosure that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification or annexed drawings, or the like.

It will be apparent to those skilled in the art that various modifications and variations can be made in the subject disclosure without departing from the scope or spirit of the subject disclosure. Other embodiments of the subject disclosure will be apparent from consideration of the specification and annexed drawings, and practice of the subject disclosure as described herein. It is intended that the specification, illustrations in the annexed drawings, and examples be considered as non-limiting illustrations only, with a true scope and spirit of the disclosure being indicated by the following claims.

What is claimed is:

1. A method, comprising:
providing a substrate of a first material; and
texturizing the substrate with a process effective to produce a plurality of protrusions located at a surface of the substrate, the texturizing step yielding a textured slab exhibiting absorption of electromagnetic radiation at gigahertz frequencies.

2. The method of claim 1, wherein the gigahertz frequencies span the range from about 1 GHz to about 20 GHz.

3. The method of claim 1, wherein the absorption of electromagnetic radiation at gigahertz frequencies increases with coverage of the surface of the substrate, the coverage provided by the plurality of protrusions.

4. The method of claim 1, wherein the absorption of electromagnetic radiation at gigahertz frequencies increases with height of each protrusion of the plurality of protrusions.

5. The method of claim 1, wherein the textured slab exhibits absorption of electromagnetic radiation at about 20 GHz, the absorption being enhanced by a factor of about 3 with respect to absorption of electromagnetic radiation at about 20 GHz exhibited by the substrate.

6. The method of claim 1, wherein the plurality of protrusions forms a disordered array.

7. The method of claim 1, wherein the plurality of protrusions forms an ordered array.

8. The method of claim 1, wherein the plurality of protrusions is arranged in a periodic lattice.

9. The method of claim 8, wherein the periodic lattice is represented by a plurality of lattice vectors, each lattice vector representing a single protrusion of the plurality of protrusions.

10. The method of claim 5, wherein the periodic lattice is a lattice with a basis, the basis comprising two protrusions of the plurality of protrusions.

11. The method of claim 1, wherein each of the plurality of protrusions has a shape comprising a confined base in contact with the surface of the substrate, the confined base being a lamina having a predetermined perimeter.

12. The method of claim 1, wherein the texturizing step comprises machining the substrate according to a predetermined design for the plurality of protrusions.

13. The method of claim 1, wherein the texturizing step comprises injection molding of a monolithic slab of the first material with a textured mold shaped according to a predetermined design of the plurality of protrusions.

14. The method of claim 1, wherein the texturizing step comprises:
compression molding of a monolithic slab of the first material; and
processing of the compressed monolithic slab to yield the plurality of protrusions, the processing comprising one or more of a machining step or an etching step.

15. The method of claim 1, wherein the texturizing step comprises:
coating the substrate with a second material; and
machining the coated substrate according to a predetermined design for the plurality of protrusions.

16. The method of claim 1, wherein the textured slab has a thickness from the group of about 10 mm, about 8 mm, about 6 mm, about 4 mm, about 3 mm, and about 2 mm.

17. The method of claim 1, wherein the textured slab has a thickness in the range of about 2 mm to about 10 mm.

18. The method of claim 1, wherein the substrate has a thickness in the range of about 1 mm to about 2 mm.

19. The method of claim 1, wherein the substrate has a thickness smaller than about 2 mm.

20. The method of claim 1, wherein the substrate has a thickness greater than about 1 mm.

21. A coating material, comprising:
a substrate of a first material; and
an assembly of a second material coupled to the substrate, the assembly comprising a plurality of protrusions located at a surface of the substrate,
the substrate and the assembly forming a textured slab that exhibits absorption of electromagnetic radiation at gigahertz frequencies.

22. The coating material of claim 21, wherein the gigahertz frequencies span the range from about 1 GHz to about 20 GHz.

23. The coating material of claim 21, wherein the absorption of electromagnetic radiation at gigahertz frequencies increases with coverage of the surface of the substrate, the coverage provided by the plurality of protrusions.

24. The coating material of claim 21, wherein the absorption of electromagnetic radiation at gigahertz frequencies increases with height of each protrusion of the plurality of protrusions.

25. The coating material of claim 21, wherein the textured slab exhibits absorption of electromagnetic radiation at about 20 GHz, the absorption being enhanced by a factor of about 3 with respect to absorption of electromagnetic radiation at about 20 GHz exhibited by the substrate.

26. The coating material of claim 21, wherein the plurality of protrusions forms a disordered array.

27. The coating material of claim 21, wherein the plurality of protrusions forms an ordered array.

28. The coating material of claim 21, wherein the plurality of protrusions is arranged in a periodic lattice.

29. The coating material of claim 21, wherein the periodic lattice is a square lattice.

30. The coating material of claim 21, wherein the periodic lattice is a hexagonal lattice.

31. The coating material of claim 21, wherein the periodic lattice is represented by a plurality of lattice vectors, each lattice vector representing a single protrusion of the plurality of protrusion.

32. The coating material of claim 21, wherein the periodic lattice is a lattice with a basis, the basis comprising two protrusions of the plurality of protrusions.

33. The coating material of claim 21, wherein each of the plurality of protrusions has a shape comprising a confined base in contact with the surface of the substrate, the confined base being a lamina having a predetermined perimeter.

34. The coating material of claim 21, wherein the first material and the second material are substantially the same, the first material being a conductive thermoplastic composite.

35. The coating material of claim 34, wherein the conductive thermoplastic composite comprises a plurality of conductive fibers dispersed in a polymer matrix.

36. The coating material of claim 35, wherein the plurality of conductive fibers define a specific volumetric loading of the polymer matrix.

37. The coating material of claim 34, wherein the textured slab is monolithically formed from machining the substrate according to a predetermined design for the plurality of protrusions.

38. The coating material of claim 34, wherein the textured slab is monolithically formed from etching the substrate according to a predetermined mask design effective to yield the plurality of protrusions.

39. The coating material of claim 34, wherein the textured slab is monolithically formed from injection molding of a monolithic slab of the first material with a textured mold shaped according to a predetermined design effective to yield the plurality of protrusions, the monolithic slab comprising the substrate and the assembly, and the second material being the same as the first material.

40. The coating material of claim 34, wherein the textured slab is monolithically formed from compression molding of a monolithic slab of the first material, and processing of the compressed substrate to yield the plurality of protrusions, the processing comprising one or more of a machining step or an etching step, the monolithic slab comprising the substrate and the assembly, and the second material being the same as the first material.

41. The coating material of claim 21, wherein the first material is a first conductive thermoplastic composite.

42. The coating material of claim 39, wherein the second material is a second conductive thermoplastic composite.

43. The coating material of claim 42, wherein the textured slab is monolithically formed from:
coating the substrate with a second material; and
machining the coated substrate according to a predetermined design for the plurality of protrusions.

44. The coating material of claim 42, wherein the textured slab is monolithically formed from:
coating the substrate with a second material; and
etching the coated substrate according to a predetermined mask design effective to yield the plurality of protrusions.

45. The coating material of claim 42, wherein the textured slab is formed from adhesive bonding of each protrusion of the plurality of protrusion to the substrate.

46. The coating material of claim 42, wherein the textured slab is formed from ultrasonic welding of each protrusion of the plurality of protrusion to the substrate.

47. The coating material of claim 21, wherein the textured slab has a thickness from the group of about 60 mm, about 50 mm, about 40 mm, about 30 mm, about 20 mm, about 10 mm, about 8 mm, about 6 mm, about 4 mm, about 3 mm, and about 2 mm.

48. The coating material of claim 21, wherein the textured slab has a thickness in the range of about 2 mm to about 60 mm.

49. The coating material of claim 21, wherein the substrate has a thickness in the range of about 1 mm to about 2 mm.

50. The coating material of claim 21, wherein the substrate has a thickness smaller than about 2 mm.

51. The coating material of claim 21, wherein the substrate has a thickness greater than about 1 mm.
